(19) United States
(12) Patent Application Publication
(10) Pub. No.: US 2016/0315652 A1
(43) Pub. Date: Oct. 27, 2016

(54) MOBILE DEVICE CASE

(71) Applicant: PERI, INC., Irvine, CA (US)

(72) Inventors: Mohammad Tabatabai, Newport Coast, CA (US); Cedrec Sumimoto, Irvine, CA (US); Michael Hsu, Irvine, CA (US)

(73) Assignee: PERI, INC., Irvine, CA (US)

(21) Appl. No.: 15/203,036

(22) Filed: Jul. 6, 2016

Related U.S. Application Data
(63) Continuation of application No. PCT/US2015/045462, filed on Aug. 17, 2015.
(60) Provisional application No. 62/038,054, filed on Aug. 15, 2014.
(60) Provisional application No. 62/120,258, filed on Feb. 24, 2015.
(60) Provisional application No. 62/120,259, filed on Feb. 24, 2015.

(51) Int. Cl. H04B 1/3888; H04W 4/00; H04M 1/18

(52) U.S. Cl. CPC H04B 1/3888; H04M 1/185; H04W 4/008; H04M 2250/02; H04M 2250/06

(57) ABSTRACT

A protective case for a mobile device includes at least one speaker and first and second wireless communication modules for first and second wireless communication protocols. In some embodiments the case includes a battery. In some embodiments the case in the case includes a sliding interface for connecting the case and mobile device. In some embodiments the case includes at least one ambient light device. The wireless interfaces of the case allow connection between multiple cases such the one case can broadcast a signal to multiple cases.

### CROSS REFERENCE TO RELATED APPLICATIONS

This application is a continuation of PCT Application No. US2015/045462U.S, titled “Mobile Device Case,” and filed on Aug. 17, 2015, which in turn claims priority to, and any other benefit of, U.S. Provisional Patent Application Ser. No. 62/038,054, filed Aug. 15, 2014 entitled “CELL PHONE CASE WITH INTEGRATED FEATURES,” U.S. Provisional Patent Application Ser. No. 62/120,259, filed Feb. 24, 2015 entitled “CELL PHONE CASE WITH SLIDING LOCKING MECHANISM,” and U.S. Provisional Patent Application Ser. No. 62/120,258 filed Feb. 24, 2015 entitled “MULTIPLE-AUDIO-STEM-TRANSMISSION (MAST),” the entire disclosures of which are incorporated herein by reference as though fully recited herein.

### TECHNICAL FIELD

The present invention relates generally to portable electronic devices, and more specifically to a protective case for use with cellular phones.

### BACKGROUND OF THE INVENTION

Today's mobile devices serve countless functions. They are used as communication devices, music players, video game platforms, business consoles, and for social media interaction. Such mobile devices suffer from many drawbacks, however, which limit their potential functionality. For example, such devices often include weak and substandard speakers, as device makers are forced to sacrifice audio quality due to space and pricing concerns (as well as other concerns relating to radio frequency and electromagnetic interference). Accordingly, mobile device users often purchase third-party portable wired or wireless speakers to improve sound quality. Such speakers are not easily transportable. Similarly, battery space in such devices is limited, and with heavy usage, users often face the choice finding a place to recharge (during which time use of the device is difficult) or avoid using the device to conserve power.

Perhaps most importantly, mobile devices are expensive and contain fragile components, such as touch screens, which is why the vast majority of mobile device users purchase some form of protective case for their mobile device. Typically, however, such cases provide no additional functionality and must often be removed when connecting the mobile device to third-party devices such as a speaker docks.

### SUMMARY

The present application discloses a removable protective case connectable to a mobile device. According to one aspect the invention, a protective case includes at least one speaker, a first wireless communications module effectuating wireless communication in a first wireless communication protocol and a second wireless communications module effectuating wireless communication in a second wireless communication protocol.

According to another aspect of the invention, a protective case includes an interface for connecting the case and the mobile device. The interface is slideable within the case and sliding the interface toward the mobile device connects the case to the mobile device and locks the mobile device within the case.

According to a further aspect of the invention, a protective case includes at least one speaker, a first wireless communications module effectuating wireless communication in a first wireless communication protocol, a second wireless communications module effectuating wireless communication in a second wireless communication protocol, a memory, a control circuit having a processor, a microphone, at least one ambient light device, a digital-to-analog converter, a battery, induction coil circuitry, a third wireless communications module effectuating wireless communication in a third wireless communication protocol, an interface for physical connection with the mobile device and an external storage drive.

### BRIEF DESCRIPTION OF THE DRAWINGS

These and other features and advantages of the present invention will become better understood with regard to the following description and accompanying drawings in which:

FIG. 1 illustrates a schematic diagram of an exemplary mobile device case;

FIG. 2 illustrates a back-side view of an exemplary mobile device case;

FIG. 3 illustrates a side view of an exemplary mobile device case;

FIG. 4A illustrates an exemplary slideable connector for a mobile device case in an up position;

FIG. 4B illustrates the exemplary slideable connector of FIG. 4A in a down position;

FIG. 4C illustrates an exploded view of the exemplary slideable connector of FIG. 4A;

FIG. 5 illustrates a front-side view of an exemplary mobile device case;

FIG. 6 illustrates a front-side view of another exemplary mobile device case;

FIG. 7 illustrates a bottom-side view of an exemplary mobile device case;

FIG. 8 illustrates a partial front-side view of an exemplary mobile device case.

### DETAILED DESCRIPTION

The present application discloses a protective case for a mobile device with integrated wireless high-fidelity speakers and other features. Users of the device no longer need to worry about purchasing separate wireless speakers that must be carried around in addition to the mobile device. Innovative wireless features allow simultaneous wireless music play on multiple devices. Other features of the protective case provide users with added functionality otherwise missing from their mobile device, such as increase battery life, wireless battery charging, ambient light for photography and video, and more. These and other features, described more fully herein, form a unique protective accessory that provides unheard-of additional functionality to typical mobile devices without need for the multitude of third-party peripheral devices currently necessary to achieve the same functionality.

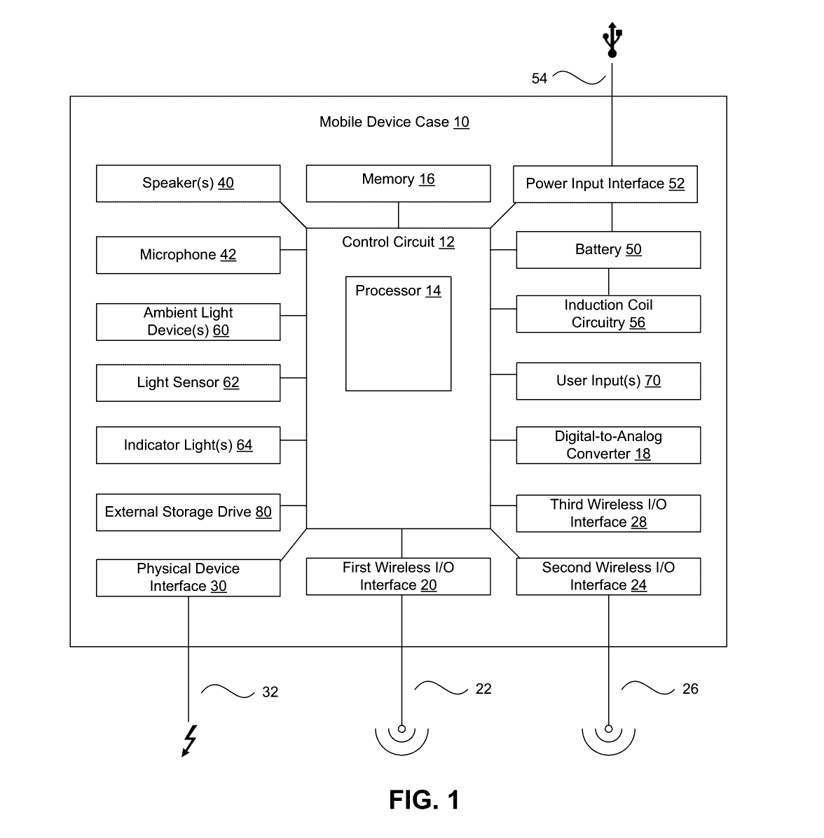

FIG. 1 is schematic diagram of an exemplary mobile device case 10 including a multitude of components and features, each of which will be described in further detail herein. While the exemplary mobile device case 10 is intended to illustrate a device having all of the various components and features described herein, it should be understood that in some embodiments, a mobile device case according to the present invention may include only a subset of the components or features.

As a brief overview, the exemplary mobile device case 10 includes a control circuit 12 with a processor 14. The control circuit 12 is connected to a memory 16 and a high-definition digital-to-analog converter 18. The exemplary mobile device case 10 further includes a first wireless input/output interface 20 connected to a first antenna 22 and a second wireless input/output interface 24 connected to a second antenna 26. A third wireless input/output interface 28 is further included. The control circuit 12 is also connected to a physical device interface 30, which is further connected to physical device connector 32. The exemplary mobile device case 10 also includes at least one speaker 40 and a microphone 42 connected to the control circuit 12. A battery 50 is further included, which is also connected to a power input interface 52 and port 54 and induction coil circuitry 56. The exemplary mobile device case 10 additionally includes at least one ambient light device 60 as well as a light/image sensor 62, at least one indicator light 64 and at least one user input 70, all connected to the control circuit 12. Also included is an external storage drive 80.

According to one aspect of the present invention, an exemplary mobile device case 10 includes a first wireless input/output interface 20 and a second wireless input/output interface 24. In one embodiment, the first wireless input/output interface 20 is a Bluetooth interface, i.e., complying with Bluetooth SIG standards, for example Bluetooth version 4.0. The wireless input/output interface 20 may be, for example a Microchip Bluetooth APL module.

In one embodiment the second input/output interface 24 is a packet-switched protocol, such as IEEE 802.11a, IEEE 802.11b, IEEE 802.11g, IEEE 802.11n or IEEE 802.11ac (commonly referred to as WiFi). Other WiFi-based protocols may be used, such as Apple's AirPlay, Intel's WiFi Direct (WiDi) or Miracast. WiFi Audio allows streaming of lossless audio files, for example Apple Lossless (ALAC), Free Lossless Audio Codec (FLAC) and the like for highly enhanced audio quality.

In one embodiment the case 10 includes dual antennas 22 and 26, and uses multiple-input and multiple-output (MIMO) functionality (i.e., spatial multiplexing) to provide multi-path signal propagation for increased communication capabilities for both Bluetooth and WiFi communication. In another embodiment, both the first wireless input/output interface 20 and second wireless input/output interface 22 share a single antenna. In order facilitate both protocols over that antenna, the control circuit 12 of case 10 may include access and control circuitry, for example a packet traffic arbiter, or may employ other known switching techniques such as adaptive frequency hopping.

The mobile device case 10 allows high-fidelity playback of music or other audio using one or more integrated speakers. If a mobile device is physically connected to the case 10 via physical device interface 30, then audio can be played through the speakers directly from the mobile device through that interface. If a mobile device is not connected, then audio can be played through the speakers via Bluetooth or WiFi wireless signals, as described above.

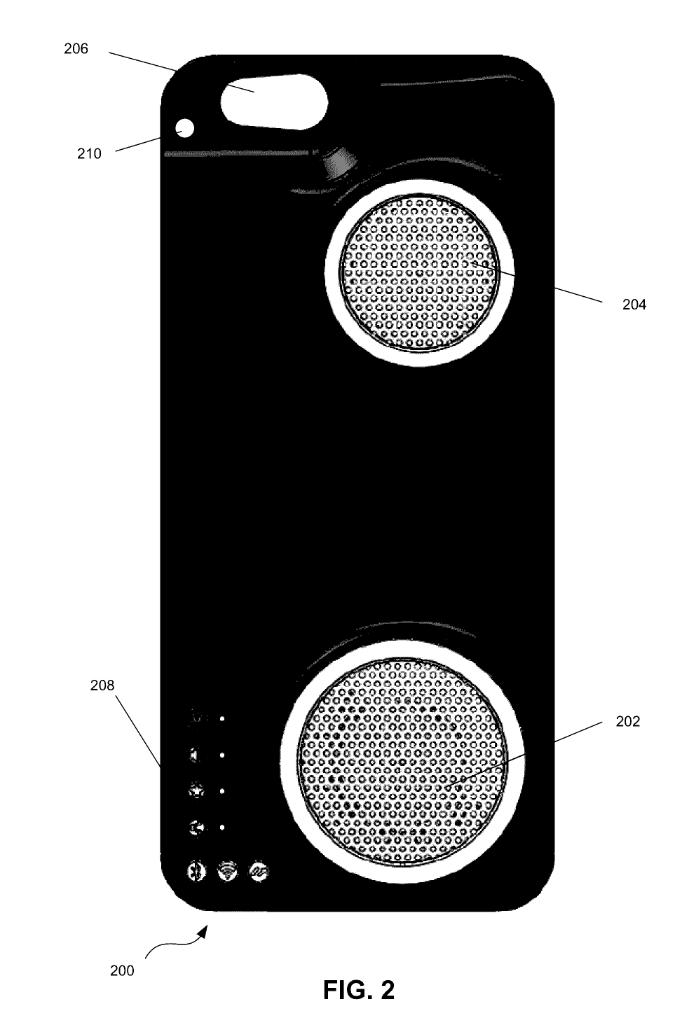

In one exemplary embodiment, shown in FIG. 2, the back side of a mobile device case 200 includes two speakers 202 and 204. The speakers may be any suitable high-fidelity speakers of any suitable power. For example, in the exemplary case 200, the speaker 202 may be a 4 W speaker and the speaker 204 may be a smaller 3 W speaker, which together may be capable of producing quality sound at least 110 dB. In other embodiments the mobile device case 200 may have a single larger speaker, while in yet further embodiments, the mobile device case 200 may have three, four or more smaller speakers. In some embodiments, speakers may be included on the front side of the case 200.

In one embodiment, in addition to the at least one speaker, the case includes at least one passive radiator. For example, in the embodiment of FIG. 2, the second speaker 204 may instead be replaced with a passive radiator. In another embodiment, one or more passive radiators are placed on the back or front side of the case in addition to the two speakers 202 and 204 to provide heightened tonality and sound quality. It would be understood by one of skill in the art that the invention is not limited to any specific number, size or arrangement of speakers and/or passive resistors.

The back side of the exemplary mobile device case 200 includes an aperture 206, through which a camera of a connected mobile device may take a picture. The back side of the exemplary mobile device case 200 also includes a set of control buttons and indicators 208, an embodiment of which is described later in further detail. In one embodiment, the back side of the exemplary mobile device case 200 additionally includes an integrated stand (not shown). The stand may be a removable piece, an extendable member, or a rotatable member that aids the case 200 in standing upright without additional support.

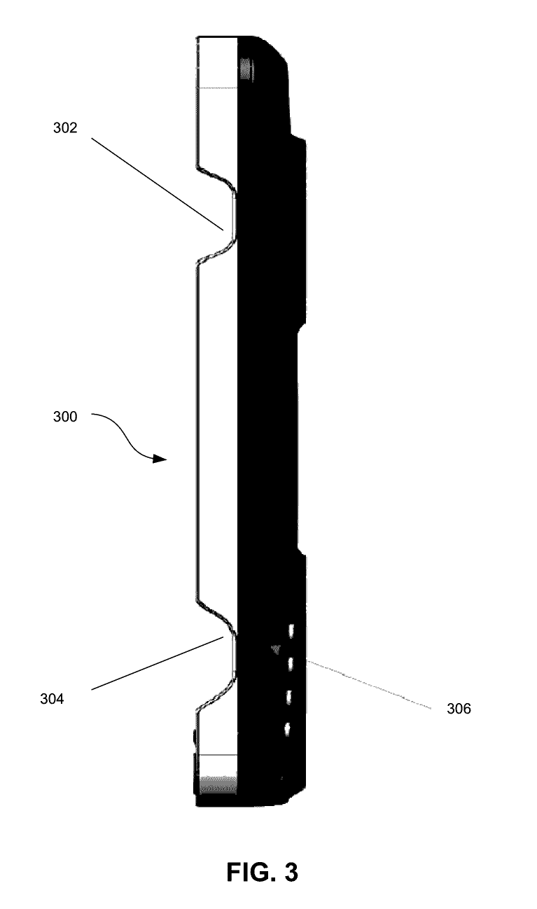

Turning briefly to FIG. 3, exemplary mobile device case 300 includes one or more side recesses, such as recesses 302 and 304 that may allow access to buttons or switches of a mobile devices when connected to the case 300. The recesses 302 and 304 may also assist a user when removing a mobile device from the case 300. The width of the sides of the case 300 may be such that the case 300 will remain in a stable upright position, without need for a support stand, if placed on its side.

The mobile device case 300 may be fashioned from any suitable material, for example a molded polymer, and may be any suitable thickness so as to accommodate the various features described herein. The case 300 may be formed by one single piece, or a plurality of pieces that connect together.

Turning back to FIG. 1, in one embodiment, the mobile device case 10 includes a microphone 42. The microphone 42 may be any suitable audio-signal capture device and associated circuitry, for example a transducer with a digital output according to the Audio Engineering Society (AES) 42 standard. The microphone 42 may be be placed at any location on the front or back side of case 10. The microphone 42, when combined with the speakers 40, may create an enhanced tool for audio-conferencing or the like.

The mobile device case described herein is designed for both protection and integration with a mobile device. Accordingly, the exemplary mobile device case 10 of FIG. 1 includes a physical device interface 30 and a physical device connector 32. The physical device interface 30 and physical device connector 32 serve to provide a wired communication link between the mobile device case 10 and a mobile device, as well as to transfer power from the mobile device case to the mobile device.

In exemplary mobile device case 10 the physical device connector 32 is a male Lightening interface for connection with a female Lightening interface of a mobile device. It should be appreciated that other connectors may be used for connection with different mobile devices, for example USB 3.0 Type A, Type B or Micro-B interfaces, or other standard or proprietary interfaces.

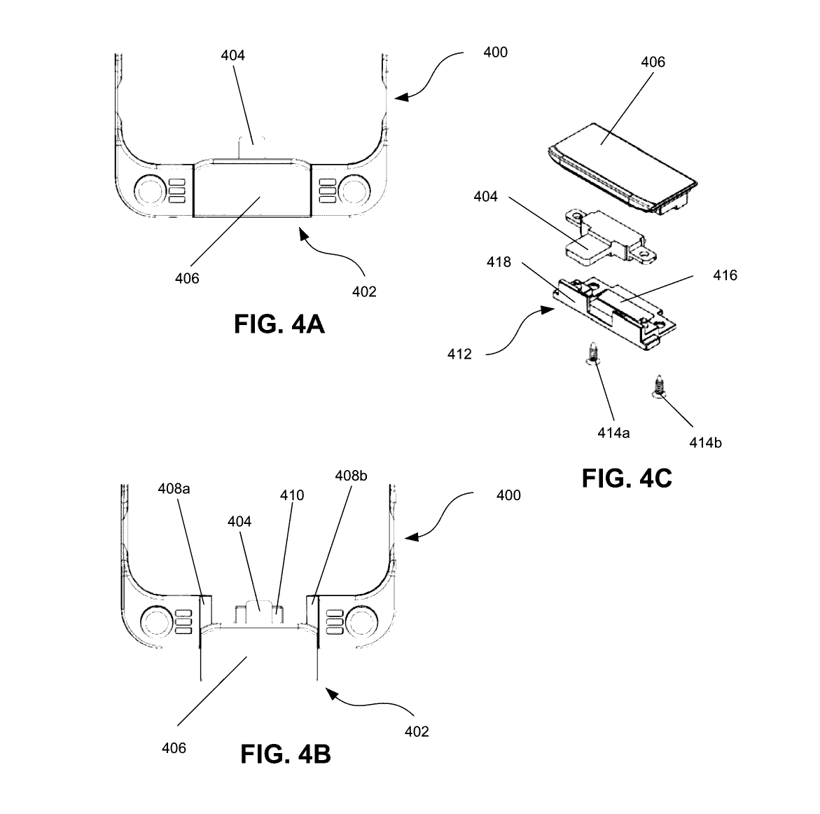

Turning to FIGS. 4A-4C, in one embodiment, an exemplary mobile device case 400 in includes a “slide guide” sliding physical device connector 402. The sliding connector 402 has the added benefit of allowing easy insertion, securing and removal of the mobile device into or out of the exemplary mobile device case 400. In operation, a user of the exemplary mobile device case 400 need simply slide connector 402 downward to move an exemplary Lightening interface 404 down below the bottom inside edge of the mobile device case 400. With no impediments, the user can fit the mobile device securely within the front cavity of mobile device case 400. Once the mobile device is inside the case 400, the user can slide the connector 402 up, which will push the Lightening male interface 404 into a corresponding female Lightening interface of the mobile device, thus locking the device into the case 400. Similarly, to remove a mobile device from the case 400, a user need only slide the connector 402 down, which will have the effect of pulling the Lightening interface 404 out from its female counterpart in the mobile device. The mobile device may then simply be pulled out from the front cavity of the case 400.

The exemplary Lightening male interface 404, is partially hidden behind a front housing 406. The exemplary mobile device case 400 includes left and right slide guides 408a and 408b, along which the sliding connector 402 may slide vertically up and down with respect to the front face of the mobile device case 400. The mobile device case 400 further includes a window 410 through which a connective wire may be fed from the Lightening interface 404 to the internal circuitry (e.g., printed circuit board assembly) of the mobile device case 400. The connective wire (not shown) may be, for example, a flat conductor cable (FCC).

The Lightening interface 404 is secured between the front housing 406 and a rear housing 412 using a pair of fasteners, such as self-threading screws 414a and 414b, though it should be appreciated that other methods of securing the housing components (e.g., glue or weld) may be used. The rear housing 412 further includes a window 416 through which the connective wire from the Lightening interface 404 may be fed. The front housing 406, rear housing 412, or both may include one or more projecting members that interact with the mobile device case 400 to prevent the sliding connector 402 from sliding up or down past a certain point or to secure the sliding connector 402 when in a fully upward position. For example, in the exemplary case 400, the rear housing 412 includes projecting member 418 to prevent the connector 402 from sliding out from the case 400. Alternatively, or additionally, the mobile device case 400 may include such members for the same purposes.

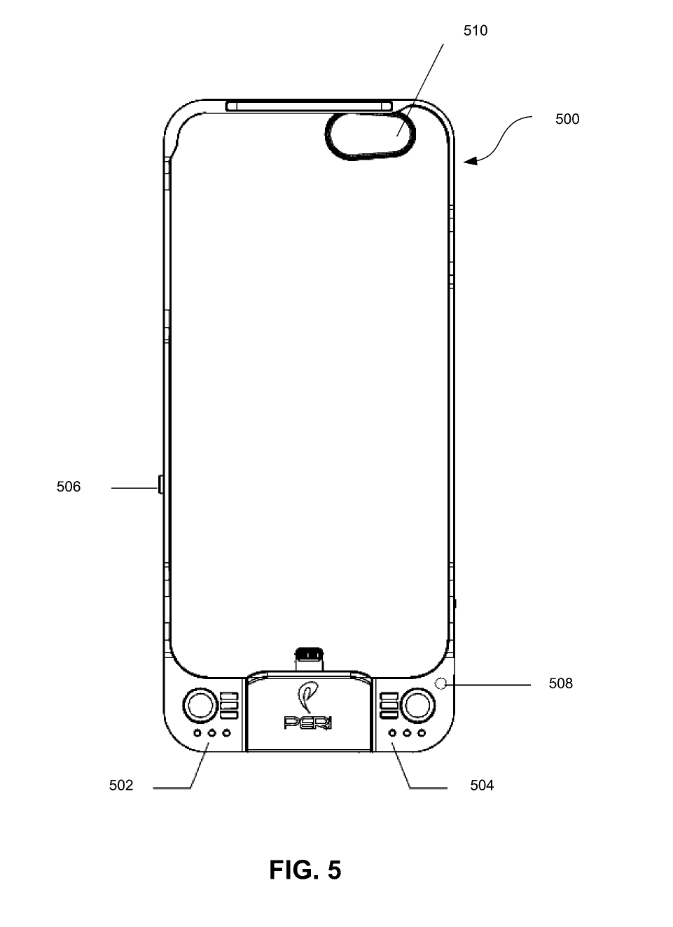

Turning to FIG. 5, in one embodiment, an exemplary mobile device case 500 further includes at least one ambient lighting device, for example the left and right sets of lighting devices 502 and 504. Such ambient lighting device(s) may be used, for example, to increase photo quality in a darker environment when taking a photograph or video recording with a camera of the mobile device. The ambient lighting device may further be used as flashlight, or to provide other visual effects.

Each of the ambient lighting devices of sets 502 and 504 may be any suitable light-producing device, for example a light-emitting diode (LED) or micro LED. Each ambient lighting device may be of any desired size or intensity, and may emit white light or colored light, or may be a multicolored light-emitting device (e.g., a tri-color RGB LED).

In some embodiments, the case 502 further includes a variable switch for controlling the brightness of the ambient lighting device, for example slider switch 506. The slider switch 506 may control brightness using a potentiometer, rheostat, variable resistor or the like, or a digital switch. In some embodiments, the case 500 includes a light or image sensor 508. The light sensor 508 may be any suitable photosensor or photodetector device, such as an active-pixel sensor (APS), charged-coupled device (CCD), photoresistor or reverse-biased LED. In some embodiments the brightness of light sets 502 and 504 is based on the level of ambient light detected by sensor 508 (e.g., using a software or firmware algorithm). In some embodiments the 502 and 504 may be turned on or off based on detection of any object (e.g., a face) in close proximity to the sensor 508. In embodiments including a switch 506, user activation of the switch 506 may automatically disable functionality of the light sensor 508.

It should be appreciated that placement of the lights 502 and 504, the number of lights, and the placement of other features such as the slider switch 506 and light sensor 508 are not limited to that shown in FIG. 5. For example, turning briefly back to FIG. 2, the exemplary case 200 includes a single lighting device 210 on the back side of the case 200, near aperture 206, though the light 210 may be located in any other suitable place. Returning to FIG. 5, in another embodiment, a single lighting device is located on the front side of the case 500. In yet a further embodiment, the case 500 includes both a light on the front and on the back sides of the case 500. In this embodiment, the case 500 may include an additional button or switch to toggle control of the variable switch 506 between the front and back lights.

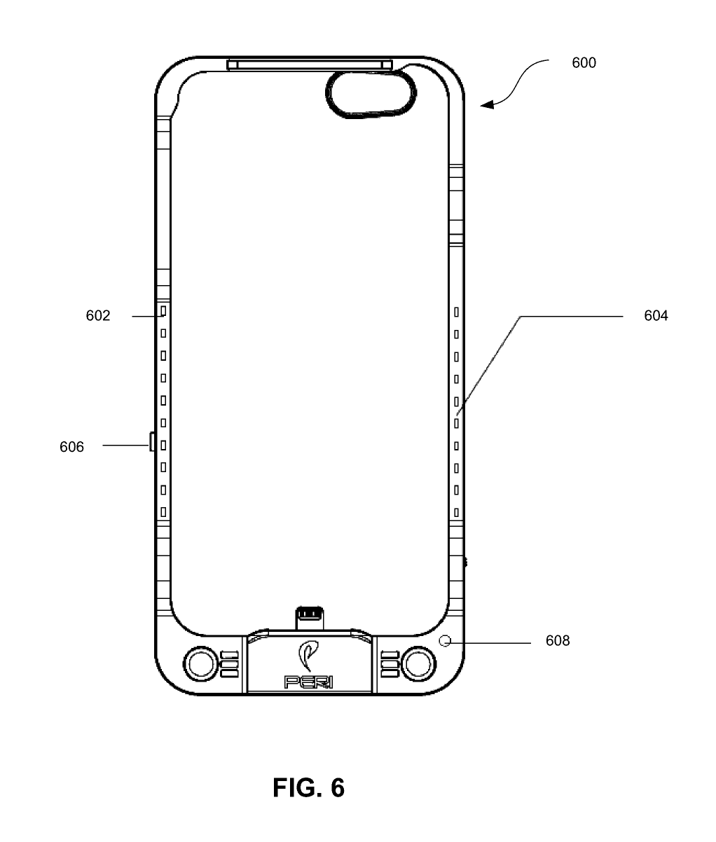

FIG. 6 shows yet another embodiment for an exemplary mobile phone case 600. Similar to the previous embodiment, exemplary case 600 includes a slider switch 606 and light sensor 608. Exemplary case 600, however, includes two linear light sets 602 and 604 running vertically up the left and rights sides, respectively, of the front side of case 600. In some embodiments, the light sets 602 and 604 continue around the periphery of the front side of the case 600 to form a ring around the case. In still embodiments, similar patterns appear instead, or sin addition, on the back side of the case 600. In yet further embodiments, a plurality of lights forms a ring around one or more speakers or other features on the back side of the case 600.

In another embodiment, brightness of the at least one light is controllable through a software application of a connected mobile device. For example, a user of the application may select which lights to turn on or off (e.g., front lights only, back lights only, or individual lights on the front or back), may select the brightness level of individual lights or select the color if multi-color light-emitting devices are used.

In one embodiment the mobile device case 10 of FIG. 1 includes a battery 50 for storing energy. The battery may power the case 10 itself (e.g., when being used as speakers without an attached mobile device). When the case 10 is physically connected to a mobile device, the battery may be used to charge the mobile device. The battery 50 may be any suitable energy storage device, for example a lithium ion battery, and may be of any suitable size, such as 2500-3000 mAh, which could increase a mobile device's charge capacity by 130-160% and allow at least an additional four hours of music playback.

The battery 50 is chargeable via power input interface 52, which accepts power through power port 54. The power interface 52 may include, for example, power conditioning and voltage/current regulation circuitry, which is know in the art. The power port 54 may be any suitable port for accepting power to charge the battery 50. For example, in the exemplary mobile device case of figure one, the port 54 is a USB port, such as USB 3.0 Type A, Type B or Micro-B interfaces, but the power port 54 may any other standard or proprietary interface.

Turning briefly again to FIG. 3, in one embodiment, an exemplary mobile device case 300 includes a slider switch 306 that allows to turn on or off charging of the mobile device. For example, when the slider switch 306 is an up position, the battery 50 will transfer power over the physical device connector 32 to charge a battery of the connected mobile device. When the slider switch 306 is a down position, no such charging will occur.

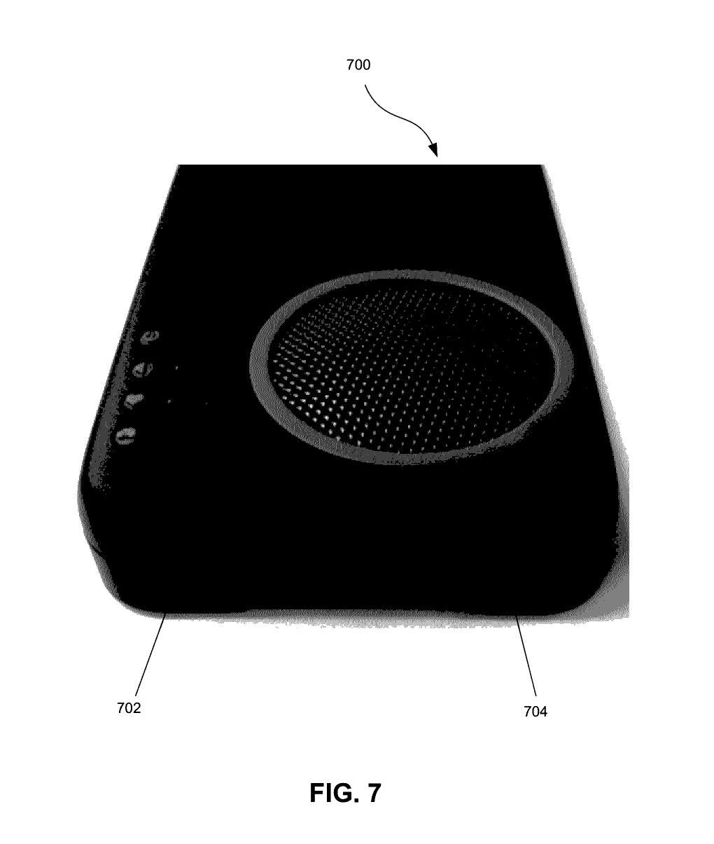

Looking now to FIG. 7, and exemplary mobile device case 700 includes a power input port 702. The exemplary power input port 702 shown is a micro USB port, but may be of any suitable type, as described above. The exemplary case 700 further includes a hole 704 through which audio cable (e.g., for headphones) may connect to a corresponding audio input jack of a connected mobile phone.

Turning back to FIG. 1, in one embodiment the mobile device case 10 includes induction coil circuitry 56, which facilities wireless charging of the battery 50 when the case 10 is placed on a wireless charging pad. The induction coil circuitry 56 may be configured to allow wireless charging using any suitable standard, for example Powermat (277-357 kHz) or Qi (100-205 kHz) or both. Wireless charging through the induction coil circuitry 56 may be used to charge battery 50 of the case 10 when no mobile device is attached or when a mobile device is attached but the mobile device charging has been turned off as described above. If a mobile device is attached, mobile device charging is turned on and the case 10 with the mobile device is placed on a wireless charging pad, then the mobile device will be charged through the case 10.

The processor 14 of the control circuit 12 of exemplary mobile device case 10 may be a central processing unit (CPU), microcontroller, or microprocessor. The processor 14 may execute code stored in a memory (not shown) within the control circuit 12 and/or in a separate memory, such as the memory 16, in order to carry out operation of the mobile device case 10. The memory 16 may be, for example, one or more of a buffer, a flash memory, a hard drive, a removable media, a volatile memory, a non-volatile memory, a random access memory (RAM), or other suitable device. In a typical arrangement, the memory 16 includes a non-volatile memory for long-term data storage and a volatile memory that functions as system memory for the control circuit 12. The memory 16 may exchange data with the control circuit 12 over a data bus. Accompanying control lines and an address bus between the memory 16 and the control circuit 12 also may be present. The memory 16 is considered a non-transitory computer readable medium.

The control circuitry 12 further includes a high-definition digital-to-analog converter (DAC) 18. In one embodiment the DAC 18 is a programmable single-chip digital signal processor (DSP). In this embodiment, the DAC 18 may be used to obtain true audio equalization by allowing a user to edit the DSP firmware using software on a connected mobile device. Some or all of the electronic components including the DAC 18, memory 16, processor 14, other control circuitry 12, and other various electronic components described in this application may be integrated onto a printed circuit board assembly (PCBA).

In one embodiment, the exemplary mobile device case 10 includes an external storage drive 80. The external storage drive may be, for example, a drive for accepting a secure digital (SD) nonvolatile memory card. The SD card may contain audio files for playback through the speakers 40 of the case 10, or may contain pictures, music, videos, or other files that can be transferred to and stored in a mobile device connected to the case 10. Similarly, data and files on a mobile device connected to the case 10 can be transferred to and stored on an SD card.

In another embodiment, the exemplary mobile device case 10 of FIG. 1 includes a third wireless input/output interface 28 that is used for near-field communication (NFC). The NFC interface 28 can be based on any suitable radio-frequency identification (RFID) protocol, for example ISO/IEC 14443, ISO/IEC 18092 or FeliCa. The NFC interface 28 may be configured to work in any of an emulation mode for uses such as payment and ticketing, a reader/writer mode for reading NFC tags, or a peer-to-peer mode for exchange of information on an ad hoc network. Data may be transmitted from the NFC interface 28 to a connected mobile device via the physical device interface 30, and vice versa.

Having both Bluetooth and WiFi capabilities, the exemplary mobile device case 10 is capable of several communication modes that add several additional capabilities. First if a mobile device is physically connected to the case 10 (i.e., via physical device connector 32) then wireless communication with the mobile device is unnecessary (and may in fact impede wireless functions of the mobile device). Accordingly, in one embodiment, the Bluetooth and WiFi modules (i.e., first and second Wireless I/O Interface 20 and 24) are automatically turned off when a mobile device is physically connected to the case 10.

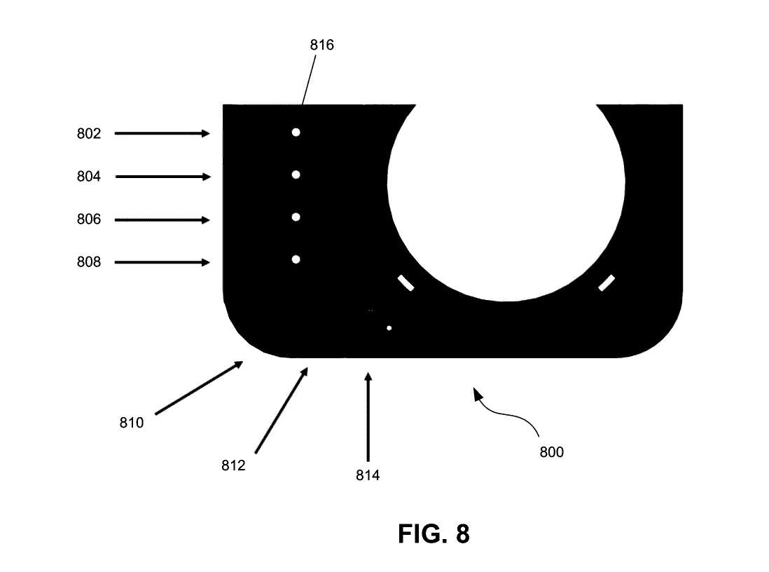

When a mobile device is not connected to the case 10, the various wireless communication methods of the case 10 may be used to interact with the mobile device. Turning to FIG. 8, the bottom back side of an exemplary mobile device case 800 is shown. The case 800 includes four exemplary buttons, 802, 804, 806 and 808 and three exemplary indicator lights 810, 812 and 814. The use of these buttons and indicators in relation to the various wireless communications modes of the case 800 will now be described in detail. One of ordinary skill in the art would understood that the arrangement of the buttons and indicators, with respect to each other or other features, or the symbols displayed thereupon are not material to their function.

According to one embodiment, a first button 802 toggles the wireless functionalities of the case 800 on or off. When the wireless functionalities of the case 800 are off, the pressing of other buttons 804, 806 and 808 will have no effect and the indicator lights 810, 812 and 814 will remain off. When the wireless functionalities of the case 800 are on, the other buttons may be used and the indicator lights will function as discussed herein. In one embodiment a long press of the button 802 turns the case 800 on and off and short press of the button 802 provides an indication of the charge level of a battery of the case 800, for example by illuminating a certain number of charge indicator lights, such as indicator light 816.

A second button 804 may be used to control volume of sound coming from one or more speakers of the case 800. For example, one or more short presses of the button 804 may alter the volume in one direction, while a long press may later the volume in the other direction. In another embodiment, alternatively or in addition, a slider button may be used to change volume. The button 804 may be used to control a volume control of a wirelessly connected mobile device (e.g., via software of the mobile device).

A third button 806 may be used stream music from a streaming source such as Spotify or iTunes. In one embodiment, a short press of the button 806 begins streaming from a preprogrammed streaming source. A long press allows a user to program or reprogram the streaming source associated with the button 806 through a software application of a mobile device.

A fourth button 808 may be used to control various wireless modes of the case 800. In one embodiment a first short press of the button 808 places the case 800 into a Bluetooth mode. In Bluetooth mode, the case will search for a previously-paired device and, if found, will connect to that device. If connected, a Bluetooth indicator 810 will illuminate and remain solidly illuminated. While in Bluetooth mode, if the button 808 is pressed and held, the case 800 will enter into a Bluetooth pairing mode, in which case 800 will seek to pair with a nearby Bluetooth-enabled device. During the pairing process, the Bluetooth indicator 810 may flash and, when pairing is complete, the indicator will turn solid. In one embodiment, a mobile device's Bluetooth address may be transferred to the case 800 when that device is physically connected to the case, either automatically or through user interaction.

A second short press of the button 808 (i.e., a short press when the case 800 is in Bluetooth mode) places the case 800 into a direct WiFi mode. In WiFi mode, the case 800 will broadcast a service set identifier (SSID) and become available as a network option for nearby WiFi-enabled mobile devices. When in WiFi mode, the WiFi indicator light 812 will illuminate. In one embodiment, access to the case 800 via WiFi may be password protected, and a password may be set or changed via a software application when the case 800 is physically connected to a mobile device.

A long press of the button 808 when the case 800 is in direct WiFi mode will place the case 800 into a WiFi access connectivity mode for connection to a home network. The WiFi access connectivity mode may utilize, for example, Apple's Wireless Accessory Configuration (WAC) feature, to make the 800 available as device on a local area network. Once on a local area network, speakers of the case 800 may be controlled by and used to play music streaming from other devices on the network. In some instances, when using the case 800 for the first time, it may be advantages to immediately enter into the WiFi access connectivity mode to set up the WAC connection.

A third short press of the button 808 (i.e., a short press when the case 800 is in WiFi mode) places the case 800 into a sharing mode. The sharing mode allows the case 800 to interact with other similar cases according to the present invention to create a multicast functionality. The multicast functionality may be effectuated through existing WiFi-enabled protocols such as Apple's AirPlay, Intel's WiFi Direct (WiDi) or Miracast, or through a proprietary multi-node streaming protocol. In one embodiment the case 800 can be set to either a master or slave setting. The master/slave setting can be set by a user through a mobile device that is or is not physically connected to the case 800, or through a button press on the case 800 (e.g., a long press in sharing mode) or by opting in to a share request as discussed further below. The sharing-mode indicator light 814 may be used to indicate whether the case 800 is in master or slave mode.

A long press when in sharing mode may place the case 800 into a master mode and broadcast a request via the multicast functionality for other similar cases (or other similarly enabled devices) to join the multicast as slaves. Audio signals received for playback through the case 800 are then broadcast via the multicast functionality for playback by all slave devices in the multicast, allowing music to be played from several devices simultaneously. The user of master device (in this case 800) will be able to control playback for all active slave devices.

If the case 800 is in slave mode, it may receive a request to join a multicast. The case may provide a notification to the user, for example by flashing the sharing-mode indicator light 816 or providing a tonal notification such as beep, that may be accepted by pressing the button 808. Alternatively, or additionally, if the case 800 is physically connected to a mobile device, a mobile device may receive a notification of the multicast request and the user may join the multicast by interacting with a software application of the mobile device.

In a further embodiment the multicast functionality may be used play individual stems, submixes, subgroups or busses of an audio mix each on a different case joined to a multicast. Current audio files (e.g., MP3, MPEG4, .WAV, RIFF, IFF, AIFF, LPCM) are digitally mixed for audio replay, and thus are not easily separable (if separable at all) into constituent tracks. If digital stem sources are available, however, it is possible to play each track individually. In a multicast, the master device (as described above) may assign each stem source to a specific WiFi transmission packet to play each stem file simultaneously through a different case's speaker. This allows for each musical instrument (e.g., guitar, bass drum, violin, piano, vocals, etc.) to play separately and simultaneously on different speakers as part of the original. The controller of the master case, e.g., through software on a mobile device linked to the case, may choose which stems to broadcast. Further, by adjusting the volumes on different slave case speakers and/or by choosing a subset of stems, it is possible for a user or group of users to create entirely new mixes of original songs.

While the present invention has been illustrated by the description of embodiments thereof and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and/or illustrative examples shown and described. Accordingly, departures may be made from such details without departing from the spirit or scope of the applicants' general inventive concept.

For example, mobile devices such as cellular phones, tablets, personal digital assistants (PDAs) and the like come in numerous shapes and sizes. It is contemplated that the present invention may be used with any number of such devices. One of ordinary skill in the art should have no difficulty altering the size or arrangement of the numerous components and features disclosed herein to accommodate other current or future mobile devices having differing shapes or sizes. Similarly, to the extent such mobile devices include different connection protocols or software related to any of the embodiments herein, one of ordinary skill in the art would be able to modify the disclosed invention to be compatible with such protocols or software with little effort.

We claim:

1. A removable protective case connectable to a mobile device, the removable protective case comprising:
at least one speaker;
a first wireless communications module effectuating wireless communication in a first wireless communication protocol; and
a second wireless communications module effectuating wireless communication in a second wireless communication protocol.

2. The protective case of claim 1 wherein the first wireless communication protocol is a Bluetooth protocol;

3. The protective case of claim 1 wherein the second wireless communication protocol is a WiFi protocol;

4. The protective case of claim 1, further comprising a battery.

5. The protective case of claim 4, further comprising a switch controlling whether charge stored in the battery is provided to the mobile device when the mobile device is connected to the protective case.

6. The protective case of claim 1, further comprising an interface for connecting the case and the mobile device, wherein the interface is slideable with the case and wherein sliding the interface toward the mobile device connects the case to the mobile device and locks the mobile device within the case.

7. The protective case of claim 1, further comprising at least one ambient light device.

8. The protective case of claim 7 further comprising a sensor, wherein brightness of the at least one ambient light device is based on an input of the sensor.

9. The protective case of claim 7, the at least one ambient light device comprising a plurality of light devices along left and right side of a front face of the protective case.

10. The protective case of claim 7, wherein the at least one ambient light device is on a front face of the protective case.

11. The protective case of claim 7, wherein the at least one ambient light device is on a rear face of the protective case.

12. The protective case of claim 1, further comprising a microphone.

13. The protective case of claim, 1 further comprising induction coil circuitry.

14. The protective case of claim 1, further comprising a third wireless communications module effectuating wireless communication in a third wireless communication protocol.

15. The protective case of claim 1, further comprising a digital-to-analog converter.

16. The protective case of claim 1, further comprising an external storage device.

17. The protective case of claim 1, further comprising a button facilitating streaming of audio to the protective case from a preprogrammed audio streaming source.

18. The device of claim 1 further comprising a master and slave modes, wherein when the device is in the master mode, the it can broadcast an audio signal to be played through speakers of the similar devices that are in a slave mode.

19. A removable protective case connectable to a mobile device, the removable protective case comprising an interface for connecting the case and the mobile device, wherein the interface is slideable within the case and wherein sliding the interface toward the mobile device connects the case to the mobile device and locks the mobile device within the case.

20. A removable protective case connectable to a mobile device, the removable protective case comprising:
at least one speaker;
a first wireless communications module effectuating wireless communication in a first wireless communication protocol;
a second wireless communications module effectuating wireless communication in a second wireless communication protocol;
a memory;
a control circuit having a processor;
a microphone;
at least one ambient light device;
a digital-to-analog converter;
a battery;
induction coil circuitry;
a third wireless communications module effectuating wireless communication in a third wireless communication protocol;
an interface for physical connection with the mobile device; and
an external storage drive.

21. A removable protective case for a mobile device, the removable protective case comprising:
a battery;
at least one speaker; and
an antenna for wireless communication,
wherein audio information is transmitted wirelessly between the mobile device and the protective case and wherein the audio information is not transmitted through a physical data connection.

22. The removable protective case of claim 21, wherein the at least one speaker comprises two speakers.

23. The removable protective case of claim 21, wherein the wireless communication comprises a low-bandwidth, short-range wireless communication.

24. The removable protective case of claim 21, wherein the wireless communication comprises a high-bandwidth, ling-range wireless communication

25. The removable protective case of claim 21, further comprising a microphone.

26. The removable protective case of claim 21, wherein a portion of the protective case is removable from the protective case.

27. The removable protective case of claim 21, further comprising a power input interface for charging the battery.

28. The removable protective case of claim 26, wherein the power input interface is a micro-USB interface.

29. The removable protective case of claim 21, further comprising a button, wherein pressing and holding the button facilitates a wireless pairing mode of the protective case.

30. The removable protective case of claim 28, further comprising an indicator light indicating whether the protective case is in the wireless pairing mode.
